(19) United States
(12) Patent Application Publication
(10) Pub. No.: US 2026/0249396 A1
(43) Pub. Date: Aug. 27, 2026

(54) LASER-ASSISTED IN-SITU FORMING PROCESS USING HIGH-TEMPERATURE INERT GAS SHIELDING AND APPARATUS THEREOF

(71) Applicant: Donghua University, Shanghai (CN)

(72) Inventors: Cheng CHEN, Shanghai (CN); Penghua HE, Shanghai (CN); Weiping LIU, Toronto (CA)

(21) Appl. No.: 19/652,024

(22) Filed: Apr. 20, 2026

(30) Foreign Application Priority Data
Mar. 12, 2026 (CN) 202610300596.X

(51) Int. Cl. B23K 26/324; B23K 26/062; B23K 26/12; B23K 26/70; B23K 103/00; B29C 35/08; B29C 70/34; B29K 105/08; B29L 7/00

(52) U.S. Cl. CPC B23K 26/324; B23K 26/0626; B23K 26/123; B23K 26/127; B23K 26/702; B29C 70/34; B23K 2103/42; B29C 2035/0838; B29K 2105/0872; B29L 2007/007

(57) ABSTRACT

The present disclosure relates to the field of automated composite material placement technology, and more specifically to a laser-assisted in-situ forming process using high-temperature inert gas shielding and an apparatus thereof. The process includes supplying prepreg tape to the laying site; heating the laying site with a laser; setting up an inert gas shield around the laying site and supplying heated inert gas to form a localized inert atmosphere, while the inert gas interacts with laser radiation through convective heat transfer to create a combined heating effect; and compacting the material using a compaction roller under the shield to achieve in-situ consolidation. The apparatus includes a laying head module, a laser heating unit, an inert gas shield, and an inert gas supply unit. By creating a stable, high-temperature inert protective environment in the laser heating and compaction zones.

### TECHNICAL FIELD

The present disclosure relates to the field of automated fiber placement technology for composite materials, and more specifically to a laser-assisted in-situ forming process using high-temperature inert gas shielding and an apparatus thereof.

### BACKGROUND

Continuous fiber-reinforced thermoplastic composites (CFRTPs), such as continuous carbon fiber-reinforced polyetheretherketone (CF/PEEK) and polyphenylene sulfide (CF/PPS), are used in fields such as aerospace, new energy vehicles, and high-end equipment due to their high specific strength, high specific stiffness, excellent impact resistance, weldability, and recyclability. Laser-assisted automated placement technology rapidly and locally heats prepreg tapes at the laying site using a laser beam, melting the thermoplastic matrix. Subsequent compression by a compaction roller achieves interlaminar bonding and consolidation. This method offers advantages such as eliminating the need for an autoclave and shortening the manufacturing cycle.

However, existing laser-assisted automated placement technologies are typically conducted in open environments, presenting the following practical limitations. First, thermoplastic resin matrices (such as PEEK and PPS) are highly susceptible to oxidation, thermal degradation, or molecular chain breakage when exposed to air under the high temperatures generated by the laser (which often exceed their melting points). Second, the single-source laser heating method is susceptible to factors such as surface reflection from the prepreg and convective heat dissipation from the environment. This makes it difficult to rapidly and uniformly maintain the temperature at the laying point within the optimal melting window, particularly during high-speed laying or when processing curved components. Third, existing technologies employ methods such as extensive purging of the processing area with inert gases (e.g., nitrogen, argon, carbon dioxide, helium, and their mixtures) to suppress oxidation. However, this approach suffers from rapid gas diffusion, high consumption, and an unstable protective atmosphere. Not only does it result in high operating costs, but it also makes it difficult to establish and maintain an effective low-oxygen environment at the rapidly moving laying site. To date, there have been no published reports in the field of automated laying for thermoplastic composites regarding methods that utilize localized inert gas shielding to prevent oxidation of thermoplastic materials, increase peak laser power, and broaden the process window.

Therefore, there is an urgent need for an in-situ forming process and apparatus capable of providing stable, efficient high-temperature inert gas shielding at the laying point while the laser is heating, and capable of achieving combined thermal input and zonal temperature control.

### SUMMARY

The objective of the present disclosure is to provide a laser-assisted in-situ forming process using high-temperature inert gas shielding and an apparatus to address the issues mentioned in the prior art.

To achieve the above objective, the present disclosure provides a laser-assisted in-situ forming process using high-temperature inert gas shielding, including the following steps:

S1, material feeding and laying: feeding continuous fibers to reinforce thermoplastic, and drawing a prepreg tape to a laying site;

S2, laser-assisted heating: using a laser to heat the prepreg tape in a laying area, so a thermoplastic matrix may reach a molten or highly viscous state and meet a requirement for in-situ bonding;

S3, inert gas shielding and composite heating: setting an inert gas shield around the laying site, covering an area that includes at least a laser heating zone and a compaction zone; supplying a heated inert gas into a shield to create a localized inert atmosphere over the laying site; the inert gas, through convective heat transfer, combines with a laser heating from S2 to form a composite heating process;

S4, compaction and in-situ consolidation: under a coverage of the inert gas shield, compacting the prepreg tape subjected to composite heating using a compaction roller to achieve in-situ consolidation.

In some embodiments, in S3, the inert gas includes nitrogen, argon, carbon dioxide, helium, or a mixture thereof.

In some embodiments, in S3, at least two independent temperature-controlled zones are arranged within the inert gas shield along a laying direction, and temperature control of each zone is achieved by independently adjusting a temperature or a flow rate of the inert gas supplied to each zone.

In some embodiments, the temperature-controlled zone includes a melting and compaction zone, as well as at least one of a preheating zone and an initial cooling zone, wherein a temperature of the inert gas supplied to the melting and compaction zone is controlled to be higher than an ambient temperature and within the range of a thermoplastic matrix melting temperature Tm±30° C.

In some embodiments, the method further includes S5: monitoring the temperature at the laying site in real time, based on a deviation between a monitored temperature and a target temperature, performing a coordinated adjustment for a laser power as well as the temperature and the flow rate of the inert gas;

In some embodiments, the method further includes S6: recovering the inert gas discharged from the inert gas shield, and re-supplying it to S3 for reuse after treatment.

A laser-assisted in-situ forming apparatus using high-temperature inert gas shielding includes a laying head module, a laser heating unit, an inert gas shield, and an inert gas supply unit; the laying head module includes a laying head, a feed guide mechanism for conveying continuous fiber-reinforced thermoplastic prepreg tapes, and a compaction roller mounted at a front end of the module; the laser heating unit is mounted on one side of the laying head, and an emitted laser beam is directed toward the laying area located below and in front of the compaction roller;

The inert gas shield is fixedly mounted around the laying site and is fixedly connected to the laying head; the wall of the inert gas shield is provided with an inlet and an outlet communicating with the inert gas supply unit, and an opening is provided at aa position corresponding to a laser beam path to allow the laser beam to pass through and focus on the laying site; the compaction roller is positioned inside the inert gas shield.

In some embodiments, an opening is formed in the wall of the inert gas shield on a side adjacent to the laser heating unit, and a lower edge of the inert gas shield is provided with at least one of a flexible sealing skirt, a labyrinth-type gap structure, or a follow-up sealing structure to minimize inert gas leakage.

In some embodiments, an interior of the inert gas shield is divided into at least two independent chambers by a partition structure, with each independent chamber connected to the inert gas supply unit via a separate gas supply branch; each gas supply branch is equipped with a flow controller and a gas heater.

In some embodiments, the system further includes a gas recovery and recirculation system, wherein the gas recovery and recirculation system is connected via piping to an outlet of the inert gas shield and an inlet of the inert gas supply unit, and the piping is equipped with a filter for removing impurities and a recirculation pump for driving gas circulation.

In some embodiments, the system further includes a temperature monitoring and control system, including a controller and an infrared thermal imager; the infrared thermal imager is mounted below a laser heating unit to capture real-time thermal images of a temperature distribution within a placement area of the inert gas shield; the controller is connected to the infrared thermal imager, the laser heating unit, and the inert gas supply unit;
the controller is configured to generate and output control signals for synchronously adjusting a laser output power, as well as the temperature and flow rate of the inert gas supplied to the inert gas shield, based on a comparison of the temperature information fed back by the infrared thermal imager with preset process parameters;
the laser heating unit may be replaced with a xenon lamp or an infrared heater.

Therefore, the present disclosure provides a laser-assisted in-situ forming process using high-temperature inert gas shielding and an apparatus thereof, which offers the following benefits. By forming a stable local inert atmosphere in the laser heating zone and compaction zone through the inert gas shield, the risk of oxidative degradation of the thermoplastic resin matrix during high-temperature processing is reduced, ensuring the chemical stability of the melt interface. This improves interfacial bond strength and consistency, reduces the probability of internal defects such as porosity, and results in composite components with more stable quality. Since oxidation issues are effectively controlled, the allowable fluctuation range for key process parameters, such as laser power, laying speed, and processing temperature, is expanded. This enhances the process's tolerance to environmental variations or complex paths, thereby improving the robustness of the laying process.

Once the heated inert gas enters the shield, it not only provides a protective atmosphere but also directly transfers heat to the prepreg tape or the previously laid layer via convective heat transfer. Combined with laser radiation, this allows for a reduction in the required peak laser power while achieving the same melting effect, or an increase in laying speed at the same laser power, thereby improving laying efficiency.

By dividing the interior of the inert gas shield into multiple temperature-controlled zones (preheating zone, melting and compaction zone, and initial cooling zone) and independently adjusting the temperature and flow rate of the inert gas in each zone, the temperature gradient along the laying path can be controlled. This allows the material to soften fully in the preheating zone, melt and wet thoroughly in the melting and compaction zone, and cool smoothly in the initial cooling zone, which helps reduce thermal stress, suppress warping and deformation, and improve forming accuracy and dimensional stability.

The use of a semi-enclosed protective hood with a flexible seal at its lower edge reduces the leakage of inert gas into the environment. Meanwhile, the gas recovery and recirculation system filters and purifies the exhaust gas for reuse, thereby reducing inert gas consumption and lowering production costs.

### BRIEF DESCRIPTION OF THE DRAWINGS

FIG. 1 is a general schematic diagram of a laser-assisted in-situ forming apparatus using high-temperature inert gas shielding according to Embodiment 1 of the present disclosure;

FIG. 2 is a structural schematic diagram of the inert gas shield according to Embodiment 1 of the present disclosure;

FIG. 3 is a flowchart of a laser-assisted in-situ forming process using high-temperature inert gas shielding according to Embodiment 1 of the present disclosure;

### Marks in the Figures

1, laying head module; 101, laying head; 102, feed guide mechanism; 2, prepreg tape reel; 3, prepreg tape; 4, fiber cutting device; 5, semiconductor laser; 6, inert gas shield; 601, inlet; 602, outlet; 603, opening; 7, preheating zone; 8, melting and compaction zone; 9, initial cooling zone; 10, flexible sealing skirt; 11, infrared thermal imager.

### DETAILED DESCRIPTION

In the description of the present disclosure, it should be noted that The terms “upper,” “lower,” “inner,” “outer,” and similar terms indicating orientation or positional relationships are based on the orientations or positions shown in the drawings, or on the orientations or positions in which the product of the present disclosure is customarily placed during use. They are provided solely for the purpose of facilitating the description of the present disclosure and simplifying the description, and are not intended to indicate or imply that the devices or components referred to must have a specific orientation, be constructed in a specific orientation, or operate in a specific orientation; therefore, they should not be construed as limitations on the present disclosure.

In the description of the present disclosure, it should also be noted that, unless otherwise explicitly specified or limited, the terms “arranged,” “mounted,” and “connected” should be interpreted broadly. For example, they may refer to a fixed connection, a removable connection, or an integral connection; they may refer to a mechanical connection or an electrical connection; they may refer to a direct connection or an indirect connection via an intermediate medium; or they may refer to internal communication between two components. A person skilled in the art can understand the specific meanings of the above terms in the context of the present disclosure based on the specific circumstances.

The following provides a detailed description of some embodiments of the present disclosure with reference to the accompanying drawings. Unless otherwise indicated, the embodiments described below and the features therein may be combined with one another.

### Embodiment 1

This embodiment uses a continuous carbon fiber-reinforced polyphenylene sulfide (CF/PPS) prepreg tape as an example to detail the implementation of the process and apparatus of the present disclosure.

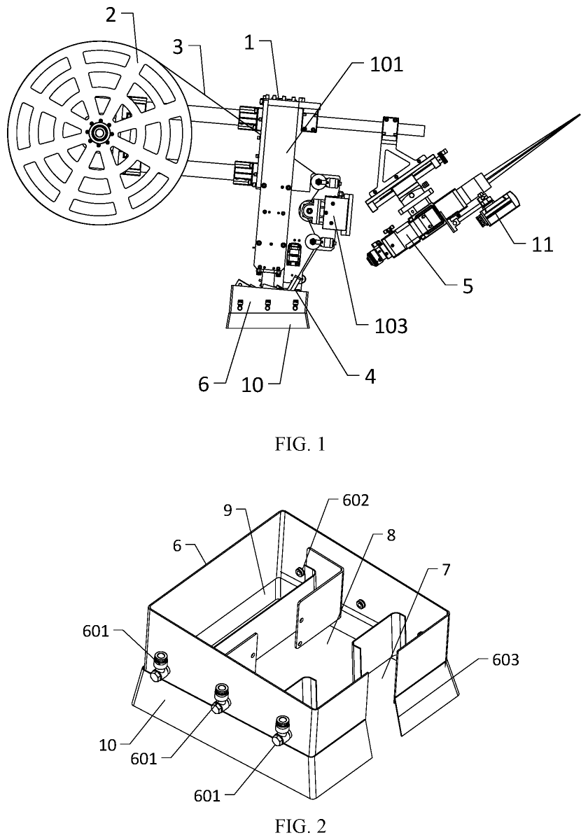

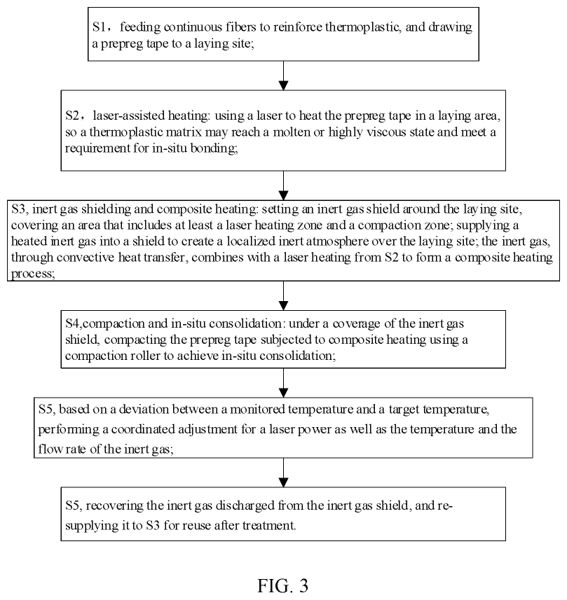

As shown in FIG. 1-FIG. 3, the substrate used in this embodiment is a unidirectional carbon fiber-reinforced PPS prepreg tape (CF/PPS) with a width of 6.35 mm and a thickness of 0.18 mm, using a flat steel mold as the laying substrate. A schematic diagram of the apparatus used in this embodiment is shown in FIG. 1. The apparatus includes a laying head module 1, a laser heating unit, an inert gas shield 6, an inert gas supply unit, a temperature monitoring and control system, and a gas recovery and recirculation system. The laying head module 1 serves as the execution terminal and is connected to the end effector of a six-axis robotic arm via a mounting flange; the robotic arm's motion path is controlled by a robotic program.

The laying head module 1 includes a laying head 101, a feed guide mechanism 102, and a compaction roller. The feed guide mechanism 102 includes a prepreg tape reel 2 and a series of guide rollers, designed to continuously and smoothly convey the prepreg tape from the reel to the laying site. A pneumatic or electric cutting device 4 is installed on the prepreg tape path at the end of the feed guide mechanism 102 and upstream of the compacting roller; this device is used to quickly and cleanly cut the prepreg tape at the end of the placement path or when material replacement is required. The compaction roller consists of a roller with a diameter of 30 mm and a surface coated with high-temperature-resistant silicone, mounted at the bottom of the laying head 101.

The laser heating unit is fixedly mounted on the side of the laying head module 1. After being transmitted through an optical fiber and focused by a collimating lens, the laser beam is directed at an angle of approximately 45° relative to the substrate plane and focused at the point of contact between the compacting roller and the mold during downward pressure, with the spot area covering the width of the prepreg tape. In this embodiment, the laser heating unit is a semiconductor laser 5, but it may also be replaced with a xenon lamp or an infrared heater.

The inert gas shield 6 is made of high-temperature-resistant stainless steel and is fixedly connected below the laying head 101. It completely encloses the compaction roller and covers the forward laying area, moving in sync with the laying head. In this embodiment, the inert gas shield 6 has a semi-enclosed box-type structure. An opening 603 is provided on the side wall of the shield directly opposite the laser beam's path of incidence, allowing the laser beam to pass through the shield and act on the laying site. The internal space of the inert gas shield 6 is divided into three independent chambers along the laying direction by partitions: the preheating zone 7, the melting and compaction zone 8, and the initial cooling zone 9. Each independent chamber is connected to the inert gas supply unit via a separate gas supply branch. Each gas supply branch is equipped with a flow controller and a gas heater to enable independent control of gas flow and temperature in each zone.

An inlet 601 is provided on the side wall of each corresponding zone of the protective hood, with an outlet located on the opposite side wall. A high-temperature-resistant silicone flexible sealing skirt 10 is installed along the lower edge of the inert gas shield 6. During placement, this skirt lightly contacts or lies very close to the mold surface, adapting to the curvature of the surface. Its primary function is to significantly reduce the leakage of inert gas from inside the shield to the outside, thereby maintaining the stability of the local atmosphere.

The temperature monitoring and control system includes an infrared thermal imager 11 and a controller. The infrared thermal imager 11 is mounted below the semiconductor laser 5 to ensure that its field of view fully covers the temperature distribution from the preheating zone 7 to the initial cooling zone 9. In this embodiment, the controller uses an industrial PLC, which receives real-time temperature data from each zone fed back by the infrared thermal imager 11 (the temperature of the preheating zone 7 is Tᵣ₁, the temperature of the melting and compaction zone 8 is Tᵣ₂, and the temperature of the initial cooling zone 9 is Tᵣ₃), and compares them with the user-preset target temperatures (the target temperature of the preheating zone 7 is T₁, the target temperature of the melting and compaction zone 8 is T₂, and the target temperature of the initial cooling zone 9 is T₃).

The infrared thermal imager 11 continuously monitors the temperature of each zone and compares it with the corresponding zone's target temperature, where ΔT1, ΔT2, and ΔT3 are defined as:

$$Δ {T}_{1} = \vert {T}_{1} - {T}_{r 1} \vert ;$$

$$Δ {T}_{2} = \vert {T}_{2} - {T}_{r 2} \vert ;$$

$$Δ {T}_{3} = \vert {T}_{3} - {T}_{r 3} \vert ;$$

where ΔT₁ is the difference between the measured temperature and the target temperature of the preheating zone, ΔT₂ is the difference between the measured temperature and the target temperature of the melting and compaction zone, and ΔT₃ is the difference between the measured temperature and the target temperature of the initial cooling zone;

If ΔT₁≥30° C., ΔT₂≥30° C., and ΔT₃≥30° C., the controller uses a coordinated algorithm to simultaneously adjust the laser power and regulate the temperature or flow rate of the gas supplied to the corresponding zone, bringing the temperature close to the target set value.

The gas recovery and recirculation system includes a recirculation pump, a filter, and a gas storage tank. The inlet of the recirculation pump is connected via piping to the outlet 602 of the inert gas shield 6. The discharged gas sequentially passes through the filter to remove any resin volatiles or condensed particles it may carry. The filtered gas is then sent to the gas storage tank and can subsequently be returned to the main gas supply line for recirculation.

This embodiment uses continuous carbon fiber-reinforced polyphenylene sulfide (CF/PPS) prepreg tape as the processing material. The specific process flow is as follows:

The CF/PPS prepreg tape reel 2 is installed onto the feeding mechanism of the laying head, and the tape passes through the guide rollers and the cutting device 4 to the position where the compaction roller engages with the substrate.

Based on the properties of the PPS resin (glass transition temperature T_{g}≈90° C., melting temperature Tₘ≈280° C.), set the following process parameters on the controller's human-machine interface: the laying path trajectory and laying speed is 20 mm/s; the laser starting power is 240 W; the pressure of the compaction roller is 300 N; the target temperature of the melting and compaction zone 8 is set to 320° C.; temperature and flow rate parameters for the inert gas supplied to each zone: Preheating zone 7 (the gas temperature is 100° C., the flow rate is 10 L/min), melting and compaction zone 8 (the gas temperature is 280° C., the flow rate is 15 L/min), and initial cooling zone 9 (the gas temperature is 90° C., the flow rate is 8 L/min).

The robotic arm drives the laying head module 1 to begin moving along a preset trajectory, while the feeding mechanism operates synchronously to convey the prepreg tape at a constant tension;
the argon gas with a temperature of 100° C. introduced into the preheating zone 7 first preheats the incoming prepreg tape and simultaneously begins to displace the air in that zone; a laser beam illuminates the laying site, providing the primary heat source. Concurrently, high-temperature argon gas with a temperature of 280° C. is continuously fed into the melting and compaction zone 8, serving two key functions: first, to create and maintain a stable, low-oxygen inert environment that inhibits the oxidation and thermal degradation of PPS at high temperatures; second, to directly heat the prepreg tape and the surface of the previously laid layer via convective heat transfer, while combining with laser radiation to enhance thermal efficiency.

An infrared thermal imager 11 continuously monitors the temperature in each zone. Based on the deviation between the measured temperature in the melting and compaction zone 8 (e.g., Tᵣ₂=285) and the target temperature (T₂=320), the controller uses a coordinated algorithm to simultaneously fine-tune the system by increasing the laser power (e.g., to 250 W) and slightly raising the gas temperature or flow rate in that zone, thereby rapidly returning the temperature to the set value.

Under inert gas shielding and precise temperature control, the prepreg tape in the molten state bonds to the mold under the pressure of the 300N compaction roller or to the previously laid prepreg tape on the mold surface, achieving high-quality in-situ consolidation.

The consolidated laminate enters the initial cooling zone 9, where it undergoes gradual, controlled cooling under a low-temperature argon gas flow at 90° C., helping to reduce residual thermal stress and warping deformation.

The gas discharged from outlet 602 is recovered, filtered, and fed into a gas storage tank, where it can be recirculated into the main gas supply line for reuse. When a single laying path is completed, the controller instructs the cutting device 4 to activate and sever the prepreg tape. It should be noted that although the present disclosure is described using the laser-assisted automatic laying process and apparatus as an example, its process philosophy, which involves creating a stable high-temperature inert environment through a local inert gas shield and employing a combination of radiant heating and high-temperature gas convective heat transfer for composite heating and zone-specific temperature control, applies to other continuous fiber-reinforced thermoplastic composites.

It should be noted that although this invention is described using the laser-assisted automated fiber placement process and apparatus as an example, its design philosophy, which involves creating a stable, high-temperature inert environment through a localized inert gas shield and employing a combination of radiant heating and high-temperature gas convection heat transfer for zone-specific temperature control, can be applied to other in-situ consolidation additive manufacturing processes for continuous fiber-reinforced thermoplastic composites, such as continuous fiber 3D printing assisted by lasers or other radiative heat sources. It is intended to address the issues of high-temperature oxidation of the thermoplastic matrix, difficult temperature control, and unstable forming quality commonly encountered in such processes.

### Embodiment 2

This embodiment demonstrates that by selecting different types of inert gases and adjusting their parameters, the present disclosure can flexibly adapt to various process requirements, thereby further expanding its scope of application.

Using the same apparatus as in Embodiment 1, the protective gas is replaced from argon to carbon dioxide (CO₂), and the laser power is set to 320 W.

The thermal conductivity of carbon dioxide at standard temperature and pressure (approximately 0.017 W/(m·K)) is lower than that of air (approximately 0.026 W/(m·K)). In this experiment, CO₂ at 200° C. and a low flow rate (10 L/min) is introduced into the melt-compaction zone 8. Due to the low thermal conductivity of CO₂ gas, convective heat dissipation is weak at low flow rates, and it primarily serves a thermal insulation function (low-flow insulation). Experimental results show that when depositing material using the same 320 W laser power as in an open environment, the temperature at the deposition point increases by 30-50° C. under this mode. This allows the material to achieve full melting without increasing, and in some cases even reducing, the laser power. This provides a new solution for processing materials with low laser absorption rates, or in scenarios where reducing laser heat input is necessary to lower energy consumption and equipment costs, thereby broadening the lower limit of the process window.

When the CO₂ flow rate is increased (to 20 L/min), although its thermal conductivity remains unchanged, the forced convection effect of the gas is significantly enhanced. The high-velocity gas flow continuously removes heat from the surface of the deposition point, and its overall cooling capacity increases with flow rate (high-flow cooling). Experimental results show that the temperature at the deposition point is 20-50° C. lower than in an open environment. This prevents resin overheating and decomposition caused by excessively high laser power settings or slow deposition speeds, thereby expanding the upper limit of the process window.

This embodiment demonstrates that the present disclosure can address the processing requirements of resins with varying thermal sensitivities (e.g., using a high-flow cooling mode for materials requiring protection against overheating, and a low-flow heat preservation mode for materials requiring thorough melting), or optimize quality and efficiency through parameter fine-tuning during the processing of the same material, this enhances the adaptability and robustness of the present disclosure's process.

### Comparative Example 1

This comparative example aims to demonstrate that, in an open environment without inert gas shielding, high-quality laying results cannot be achieved even when using the same process parameters as in Embodiment 1. As a comparison, laying is performed in an open environment without an inert gas shield under the same conditions, specifically, using the same CF/PPS prepreg tape material, laying speed (20 mm/s), laser power (240 W), and compaction pressure (300 N), the open-environment laying without an inert gas shield is conducted as a comparative example, with the entire process taking place directly in the exposed environment.

Infrared thermal imaging monitoring reveals that in the open environment, due to natural convective heat dissipation from the air, variations in the reflectivity of the laying surface, and the absence of auxiliary heat source compensation, the temperature at the laying point fluctuates extremely violently. Instantaneous temperatures fluctuate rapidly over a wide range from 250° C. to over 400° C., failing to stabilize near the preset 320° C.

During the laying process, the surface color of the prepreg tape near the laying point darkened, accompanied by slight smoke emission. This is a clear indication of thermal-oxidative aging of the PPS resin in a high-temperature, oxygen-rich environment.

Inspection of the molded laminate: Appearance and microstructure: The sample surface exhibits uneven coloration, with visible localized scorch marks. Metallographic microscopy analysis reveals a porosity as high as 3.5%, far exceeding the 0.8% observed in Embodiment 1. The pores are predominantly irregular in shape and distributed at the interlaminar interfaces; this is caused by a combination of changes in viscosity, reduced flowability, and increased volatiles resulting from the oxidation of the molten resin.

### Comparative Example 2

This comparative example aims to demonstrate that attempting to improve melting performance or speed solely by increasing laser power will lead to more severe issues in an open environment. In this comparative example, all conditions are identical to those in Comparative example 1 (open environment, no protection), except that the laser power is adjusted to 320 W (the same setting as in Embodiment 2). This power level is intended to simulate a scenario where energy input is increased to achieve higher laying efficiency or to process thicker materials.

During the laying process, infrared monitoring indicates that the instantaneous peak temperature at the laying site easily exceeds 500° C. and even approaches 570° C. This is far higher than the melting temperature of PPS (280° C.) and its thermal decomposition onset temperature. Oxidation is more pronounced and severe than in Comparative example 1, the surface quality of the molded components is poorer, the interlaminar shear strength of the final specimens is even lower than that of Comparative example 1, and porosity is not improved.

As confirmed by Comparative example 1 and Comparative example 2, the oxidative degradation of the thermoplastic matrix in an open environment is one of the fundamental causes of weakened interfacial bonding and performance variability. The present disclosure reduces the risk of high-temperature oxidative degradation by introducing a high-temperature inert gas shield and its control system; the comparative examples indicate that in an open environment, the adjustment range for process parameters (such as laser power) is very limited: if the power is too low (240 W), the temperature becomes unstable and melting is insufficient; while slightly higher power (320 W) immediately poses a risk of overheating and oxidation. The embodiments of the present disclosure demonstrate that, under inert gas shielding, the system can operate stably over a wider range of laser power and laying speeds, thereby enhancing the process's robustness and adaptability.

Finally, it should be noted that the above embodiments are provided merely to illustrate the technical solutions of the present disclosure and are not intended to limit it. Although the present disclosure has been described in detail with reference to preferred embodiments, those skilled in the art will understand that modifications or equivalent substitutions may be made to the technical solutions of the present disclosure, and such modifications or equivalent substitutions will not cause the modified technical solutions to depart from the spirit and scope of the present disclosure.

What is claimed is:

1. A laser-assisted in-situ forming process using high-temperature inert gas shielding, comprising the following steps:
S1, material feeding and laying: feeding continuous fibers to reinforce thermoplastic, and drawing a prepreg tape to a laying site;
S2, laser-assisted heating: using a laser to heat the prepreg tape in a laying area, so a thermoplastic matrix may reach a molten or highly viscous state and meet a requirement for in-situ bonding;
S3, inert gas shielding and composite heating: setting an inert gas shield around the laying site, covering an area that includes at least a laser heating zone and a compaction zone; supplying a heated inert gas into a shield to create a localized inert atmosphere over the laying site; the inert gas, through convective heat transfer, combines with a laser heating from S2 to form a composite heating process; and
S4, compaction and in-situ consolidation: under a coverage of the inert gas shield, compacting the prepreg tape subjected to composite heating using a compaction roller to achieve in-situ consolidation.

2. The laser-assisted in-situ forming process using high-temperature inert gas shielding according to claim 1, wherein in S3, the inert gas comprises nitrogen, argon, carbon dioxide, helium, or a mixture thereof.

3. The laser-assisted in-situ forming process using high-temperature inert gas shielding according to claim 2, wherein in S3, at least two independent temperature-controlled zones are arranged within the inert gas shield along a laying direction, and temperature control of each zone is achieved by independently adjusting a temperature or a flow rate of the inert gas supplied to each zone.

4. The laser-assisted in-situ forming process using high-temperature inert gas shielding according to claim 3, wherein the temperature-controlled zone comprises a melting and compaction zone, as well as at least one of a preheating zone and an initial cooling zone, wherein a temperature of the inert gas supplied to the melting and compaction zone is controlled to be higher than an ambient temperature and within the range of a thermoplastic matrix melting temperature Tm±30° C.

5. The laser-assisted in-situ forming process using high-temperature inert gas shielding according to claim 1, wherein the method also comprise S5: monitoring a temperature at the laying site in real time, based on a deviation between a monitored temperature and a target temperature, performing a coordinated adjustment for a laser power as well as the temperature and the flow rate of the inert gas;
wherein the method also comprises S6: recovering the inert gas discharged from the inert gas shield, and re-supplying it to S3 for reuse after treatment.

6. A laser-assisted in-situ forming apparatus using high-temperature inert gas shielding, which adopts the laser-assisted in-situ forming process using high-temperature inert gas shielding according to claim 1, wherein the laser-assisted in-situ forming apparatus comprises a laying head module, a laser heating unit, an inert gas shield, and an inert gas supply unit; the laying head module includes a laying head, a feed guide mechanism for conveying continuous fiber-reinforced thermoplastic prepreg tapes, and a compaction roller mounted at a front end of the module;
the laser heating unit is mounted on one side of the laying head, and an emitted laser beam is directed toward the laying area located below and in front of the compaction roller;
the inert gas shield is fixedly mounted around the laying site and is fixedly connected to the laying head; the wall of the inert gas shield is provided with an inlet and an outlet communicating with the inert gas supply unit, and an opening is provided at aa position corresponding to a laser beam path to allow the laser beam to pass through and focus on the laying site; the compaction roller is positioned inside the inert gas shield.

7. The laser-assisted in-situ forming apparatus using high-temperature inert gas shielding according to claim 6, wherein an opening is formed in the wall of the inert gas shield on a side adjacent to the laser heating unit, and a lower edge of the inert gas shield is provided with at least one of a flexible sealing skirt, a labyrinth-type gap structure, or a follow-up sealing structure to minimize inert gas leakage.

8. The laser-assisted in-situ forming apparatus using high-temperature inert gas shielding according to claim 7, wherein an interior of the inert gas shield is divided into at least two independent chambers by a partition structure, with each independent chamber connected to the inert gas supply unit via a separate gas supply branch; each gas supply branch is equipped with a flow controller and a gas heater.

9. The laser-assisted in-situ forming apparatus using high-temperature inert gas shielding according to claim 6, wherein the system further comprises a gas recovery and recirculation system, wherein the gas recovery and recirculation system is connected via piping to an outlet of the inert gas shield and an inlet of the inert gas supply unit, and the piping is equipped with a filter for removing impurities and a recirculation pump for driving gas circulation.

10. The laser-assisted in-situ forming apparatus using high-temperature inert gas shielding according to claim 6, wherein the system further includes a temperature monitoring and control system, including a controller and an infrared thermal imager; the infrared thermal imager is mounted below a laser heating unit to capture real-time thermal images of a temperature distribution within a placement area of the inert gas shield; the controller is connected to the infrared thermal imager, the laser heating unit, and the inert gas supply unit;
the controller is configured to generate and output control signals for synchronously adjusting a laser output power, as well as the temperature and flow rate of the inert gas supplied to the inert gas shield, based on a comparison of the temperature information fed back by the infrared thermal imager with preset process parameters;
the laser heating unit may be replaced with a xenon lamp or an infrared heater.
